(19) United States
(12) Patent Application Publication
(10) Pub. No.: US 2025/0075829 A1
(43) Pub. Date: Mar. 6, 2025

(54) ATTACHMENT DEVICE CONFIGURED TO ATTACH A CONDUIT TO A SUPPORT AND HAVING A CONDUIT ENGAGEMENT PORTION CONFIGURED TO RELIEVE STRAIN ON THE CONDUIT

(71) Applicant: PPC BROADBAND, INC., East Syracuse, NY (US)

(72) Inventor: Henry SAUVAIN, Syracuse, NY (US)

(73) Assignee: PPC BROADBAND, INC., East Syracuse, NY (US)

(21) Appl. No.: 18/820,379

(22) Filed: Aug. 30, 2024

Related U.S. Application Data
(60) Provisional application No. 63/536,123, filed on Sep. 1, 2023.

(51) Int. Cl. F16L 3/04; H02G 3/04

(52) U.S. Cl. CPC F16L 3/04; H02G 3/0493

(57) ABSTRACT

Embodiments provide an attachment device configured to attach a conduit to a support and to relieve strain on the conduit, including: a body portion; and a protruding portion extending from the body portion. The body portion may have a first end and a second end, wherein the second end may be opposite to the first end along a length of the body portion. The protruding portion may extend from the body portion by a depth in a direction of a thickness of the body portion. The protruding portion may extend along the longitudinal direction of the body portion. The protruding portion may be structurally configured to engage a conduit to prevent movement of the conduit relative to the attachment device in a direction of a height of the attachment device so as to relieve strain on the conduit resulting from a hanging weight of the conduit.

### CROSS-REFERENCE TO RELATED APPLICATION

This application claims the benefit of U.S. Provisional Application No. 63/536,123 filed Sep. 1, 2023, which is currently pending, the disclosure of which is hereby incorporated by reference herein in its entirety.

### BACKGROUND

The present disclosure relates generally to conduits and, in particular, to telecommunications conduits that are attached to a support structure. More particularly, the disclosure relates to a device for attaching a conduit to a support structure.

Telecommunications and other systems include wire, optical fiber, and/or other signal and/or power transmission lines that are routed through a conduit or other protective structure. The conduit, for example, can be attached to a support structure such as, for example, a tower at one or more locations along the length of the conduit.

Conduits can be run vertically and attached to a tower, pole, or other structure to guide wires, optical fibers, or other lines from a lower elevation (such as the ground) to a higher elevation (such as an antenna or other device) on, for example, a tower. Conventional devices for attaching conduits to a support structure put strain on the conduit that is being attached to the support structure.

### SUMMARY

It may be desirable to provide an attachment device that is configured to attach a conduit to a support and has a conduit engagement portion that is configured to relieve strain on the conduit. In some embodiments, it may be desirable to provide a strap having one or more protrusions extending from an inside surface of the strap that are configured to engage grooves (or other recesses or features) in an exterior surface of a conduit or other structure. The engagement of the protrusions with the grooves, for example, may provide support for the conduit at one or more locations along the length of the conduit. In the case of the conduit running vertically, such support may counteract the force of gravity acting on the conduit to relieve strain on the conduit caused by the weight of the conduit and its contents.

Embodiments provide an attachment device configured to attach a conduit to a support and to relieve strain on the conduit, including: a body portion; and a protruding portion extending from the body portion. The body portion may have a length in a longitudinal direction, a height perpendicular to the longitudinal direction, and a thickness perpendicular to the height and the longitudinal direction. The body portion may have a first end and a second end, wherein the second end is opposite to the first end along the length of the body portion. The protruding portion may extend from the body portion by a depth in a direction of the thickness of the body portion. The protruding portion may extend along the longitudinal direction of the body portion. The protruding portion may be structurally configured to engage a recessed portion of a conduit. The protruding portion may be structurally configured to engage the conduit to prevent movement of the conduit relative to the attachment device in a direction of the height of the attachment device so as to relieve strain on the conduit resulting from a hanging weight of the conduit.

In embodiments, the protruding portion may extend uniformly along the longitudinal direction of the body portion.

In embodiments, the protruding portion may extend along an entire length of the longitudinal direction of the body portion.

In embodiments, the protruding portion may extend along less than an entire length of the longitudinal direction of the body portion.

In embodiments, the protruding portion may be separated in the longitudinal direction by a gap between portions of the protruding portion.

In embodiments, the protruding portion may be separated in the longitudinal direction by gaps between portions of the protruding portion, and the gaps may be spaced along the longitudinal direction.

In embodiments, the gaps may be spaced along the longitudinal direction at uniform intervals.

In embodiments, the protruding portion may be a first protruding portion and the attachment device may further comprise a second protruding portion.

In embodiments, the first protruding portion and the second protruding portion may be spaced apart in a direction of the height of the attachment device.

In embodiments, the attachment device may further comprise a third protruding portion, and the first protruding portion, the second protruding portion, and the third protruding portion may be uniformly spaced apart in the direction of the height of the attachment device.

In embodiments, the recessed portion may comprise a groove in the conduit.

In embodiments, the protruding portion may have a cross-sectional shape, and the cross-sectional shape of the protruding portion may comprise a triangle.

In embodiments, the protruding portion may have a cross-sectional shape, and the cross-sectional shape of the protruding portion my comprise a trapezoid.

In embodiments, the protruding portion may have a cross-sectional shape, and the cross-sectional shape of the protruding portion may comprise a U-shape.

Embodiments provide an attachment device configured to attach a conduit to a support and to relieve strain on the conduit, including: a body portion; and a protruding portion extending from the body portion. The body portion may have a first end and a second end, wherein the second end may be opposite to the first end along a length of the body portion, the length extending in a longitudinal direction of the body portion. The protruding portion may extend from the body portion by a depth in a direction of a thickness of the body portion. The protruding portion may extend along the longitudinal direction of the body portion. The protruding portion may be structurally configured to engage a conduit to prevent movement of the conduit relative to the attachment device in a direction of a height of the attachment device so as to relieve strain on the conduit resulting from a hanging weight of the conduit.

In embodiments, the protruding portion may be structurally configured to engage a recessed portion of the conduit.

In embodiments, the protruding portion may extend uniformly along the longitudinal direction of the body portion.

In embodiments, the protruding portion may extend along an entire length of the longitudinal direction of the body portion.

In embodiments, the protruding portion may extend along less than an entire length of the longitudinal direction of the body portion.

Embodiments provide an attachment device configured to attach a conduit to a support and to relieve strain on the conduit, including: a body portion; and a protruding portion extending from the body portion. The protruding portion may extend from the body portion a protrusion depth. The protrusion depth may be in a direction of a thickness of the body portion. The protruding portion may extend along a longitudinal direction of the body portion. The protruding portion may be structurally configured to engage a conduit to prevent movement of the conduit relative to the attachment device in a direction of a height of the attachment device so as to relieve strain on the conduit resulting from a hanging weight of the conduit.

In embodiments, the body portion may have a first end and a second end, the second end may be opposite to the first end along a length of the body portion, the length extending in the longitudinal direction of the body portion.

In embodiments, the protruding portion may be structurally configured to engage a recessed portion of the conduit.

In embodiments, the protruding portion may extend uniformly along the longitudinal direction of the body portion.

In embodiments, the protruding portion may extend along an entire length of the longitudinal direction of the body portion.

Various aspects of the system, as well as other embodiments, objects, features and advantages of this disclosure, will be apparent from the following detailed description of illustrative embodiments thereof, which is to be read in conjunction with the accompanying drawings.

### BRIEF DESCRIPTION OF THE DRAWINGS

FIG. 1 is a perspective view of an exemplary strap in accordance with various aspects of the disclosure attached to a conduit and tower.

FIG. 2 is a side view of the strap of FIG. 1 attached to a conduit and tower.

FIG. 3 is a partial perspective view of the strap of FIG. 1 attached to a conduit and tower.

FIG. 4 is a perspective view of the strap of FIG. 1.

FIG. 5 is a sectional view of the strap of FIG. 1.

FIG. 6 is a sectional view of the strap of FIG. 1 attached to a conduit and tower.

FIG. 7 is a perspective view of the strap of FIG. 1 and a fastening clip.

### DETAILED DESCRIPTION OF EMBODIMENTS

Embodiments of the disclosure provide and attachment device, for example, a strap, that includes a protruding portion that is structurally configured to engage a conduit to prevent movement of the conduit relative to the strap in a direction of the height of the strap so as to relieve strain on the conduit resulting from a hanging weight of the conduit.

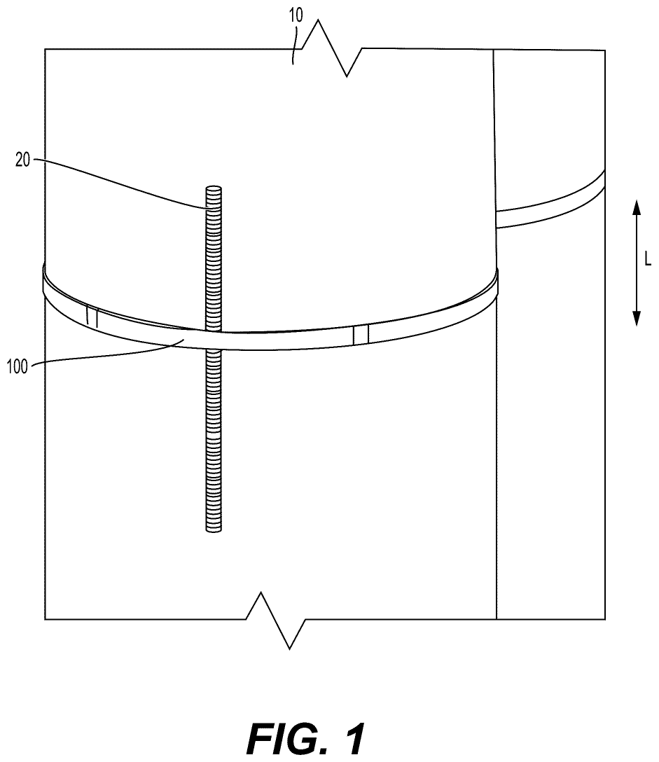

FIG. 1 shows an example of a structure 10 such as, for example, a tower, pole, or other structure to which a conduit 20 is attached. For simplicity, while the term “tower” is used to describe various embodiments of the disclosure, it is understood that embodiments are applicable to attach a conduit to other structures as well. In FIG. 1, only a portion of the conduit 20 is shown. In embodiments, the conduit 20 extends the entire height, or a substantial portion of the height, of the tower. In FIG. 1, an attachment device, for example, a strap, 100 attaches the conduit 20 to the tower 10 such that the conduit 20 is prevented from moving in a longitudinal direction L of the tower 10.

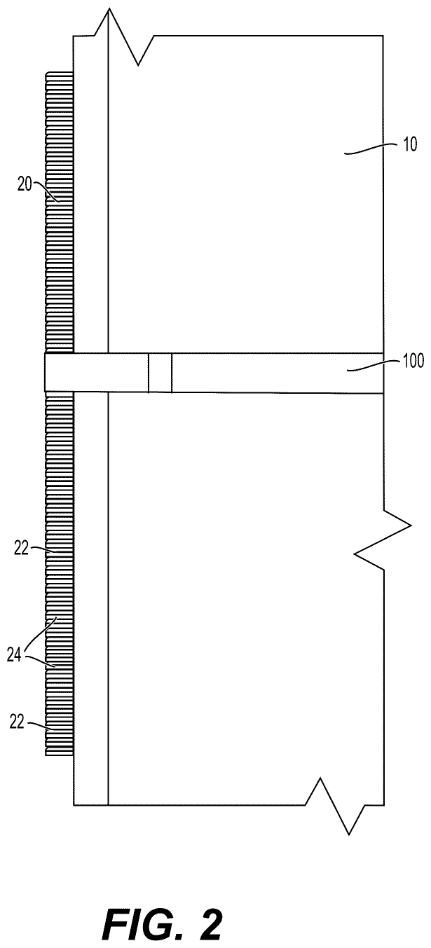

FIG. 2 is a side view of the tower 10, the conduit 20, and the strap 100 shown in FIG. 1. The example of the conduit 20 shown in FIG. 2 has a plurality of recesses such as, for example, grooves 22 in an outer surface of the conduit 20 that result in raised areas 24 in the outer surface of the conduit 20. In this example, the grooves 22 are uniformly spaced apart. In some examples of the conduit 20, the grooves increase a flexibility of the conduit 20.

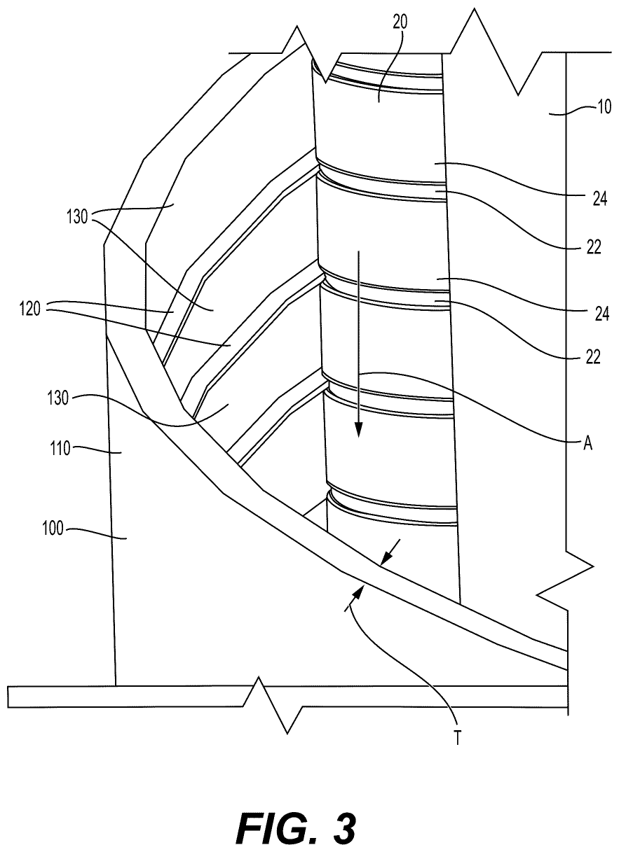

FIG. 3 shows an example of an inner surface of the strap 100 and how it can interact with the conduit 20. In the example of FIG. 3, the conduit 20 is attached to the tower 10 by the strap 100 pressing the conduit 20 tightly against the tower 10. The grooves 22 in the outer surface of the conduit 20 and the raised areas 24 in the outer surface of the conduit 20 can be seen clearly in FIG. 3. While a particular relative size and spacing of the grooves 22 is shown in FIG. 3, it is noted that embodiments can be configured to work with conduits of other configurations. In the example shown in FIG. 3, the strap 100 has a body portion, for example, a main body, 110 which has, in this example, a uniform thickness T. In some embodiments, the thickness T is in the range of from 0.03125 to 0.0625 inches. In some embodiments, the thickness T is approximately 0.06 inches. Other examples have a non-uniform thickness. Extending from the main body 110 are a plurality of protruding portions, for example, protrusions, 120. When the strap 100 is installed to secure a conduit, such as, for example, the conduit 20, to a structure, such as, for example, the tower 10, the protrusions 120 extend inwardly toward the conduit 20 and engage a feature such as, for example, the grooves 22 in the outer surface of the conduit.

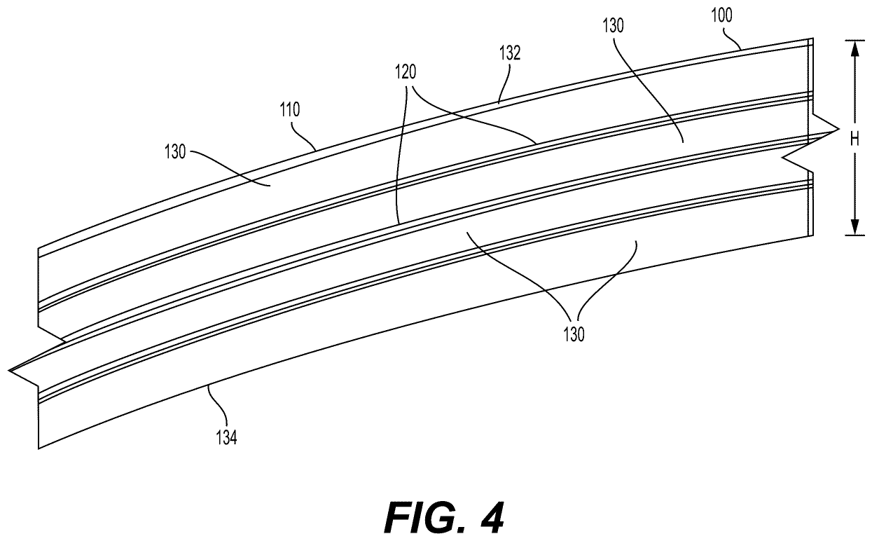

In the example shown in FIG. 3, the strap 100 has three of the protrusions 120. Other embodiments have fewer or more of the protrusions 120. In some embodiments, a distance between two adjacent ones of the protrusions 120 is in the range of from 3 mm to 8 mm. In some embodiments, the distance between two adjacent ones of the protrusions 120 is approximately 3 mm, 4 mm, 6 mm or 8 mm. For use with a conduit having grooves 22 spaced 3 mm apart, the distance between the protrusions 120 can be 3 mm (to engage every groove 22) or 6 mm to engage every other groove 22). For use with a conduit having grooves 22 spaced 4 mm apart, the distance between the protrusions 120 can be 4 mm (to engage every groove 22) or 8 mm to engage every other groove 22). In this example, the protrusions 120 are evenly spaced along a height H (see FIG. 4) of the main body 110 of the strap 100. In some embodiments, the height H is in the range of from 0.375 to 2.0 inches. In some embodiments, the height H is approximately 0.5 inches. In some examples, a protrusion 132 is located on one of the longitudinal edges of the main body 110 and/or a protrusion 134 is located on one the of the edges of the main body 110 (see FIG. 4).

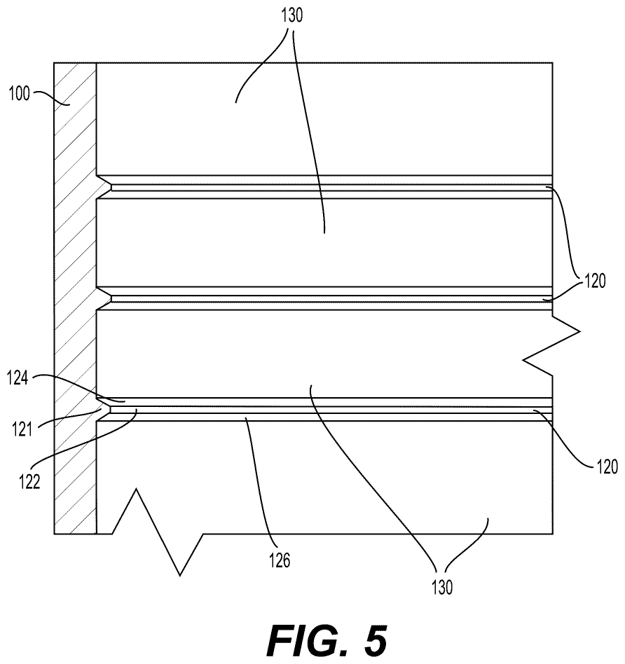

In some embodiments, a distance that the protrusions 120 extend from the main body 110 is determined by the size of the grooves 22 in the conduit being secured to the tower 10. For example, in some embodiments, the distance that the protrusions 120 extend from the main body 110 is 0.4 mm. In some embodiments, a height of the protrusions 120 in the direction of the height H of the main body 110 is determined by the size of the grooves 22 in the conduit being secured to the tower 10. For example, in some embodiments, the height of the protrusions 120 is 0.024 inches at its base and 0.006 inches at its face 122 (see FIG. 5).

FIG. 3 shows how one or more of the protrusions 120 and/or the protrusion 132 and/or the protrusion 134 engages the grooves 22 to prevent movement of the conduit 20 in a direction A (for example, a vertical direction) relative to the strap 100. By tightening the strap 100 around the conduit 20 and the tower 10, friction between the strap 100 and the tower 10 and/or between the conduit 20 and the tower 10, movement of the conduit 20 relative to the tower 10 is resisted or eliminated.

The conduit 20 can contain wires, optical fiber, or other lines that add weight to the conduit 20. This weight, as well as the weight of the conduit 20 itself, especially in the case of a tall tower 10, for example, can result in a significant strain on a long run of the conduit 20. The engagement of the protrusions 120 with the grooves 22 provides support, for example vertical support, for the conduit 20 at each location of the strap 100. The strap 100 can be installed at a plurality of locations alone the length (height) of the tower 10 to relieve the above-described stress on the conduit 20.

FIG. 5 shows a sectional view of an example of the strap 100 in which the protrusions 120 are trapezoidal in cross-section 121 (for example, with a 60 degree angle). In this example, each of the protrusions 120 has a first side (in this example, an upper side) 124, and a second side (in this example, a lower side) 126 that are connected by a face 122. Other examples provide the protrusions with a triangular cross-section, a square cross-section, a rectangular cross-section, a U-shaped cross-section, a semi-circular or other curved cross-section, or cross-sections of other shapes. In embodiments, the shape of the cross-section of the protrusions 120 is configured to securely engage a particular shape of grooves or other recesses in a conduit.

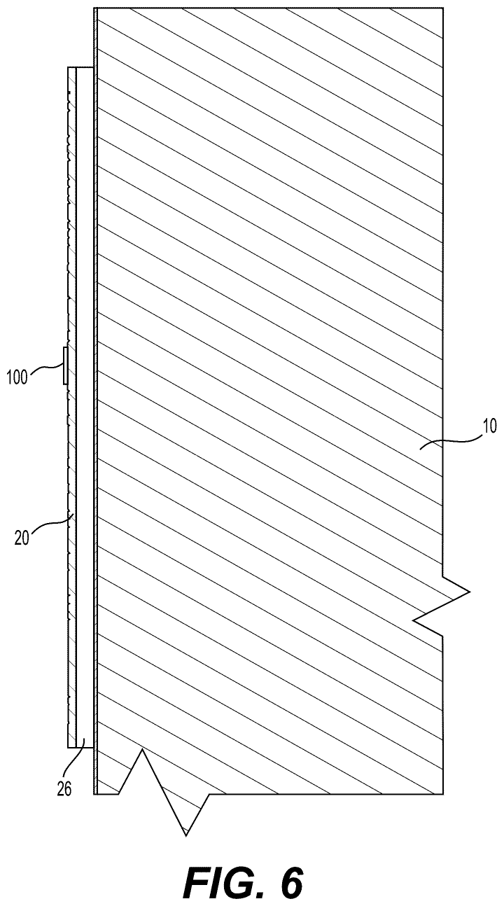

FIG. 6 shows a sectional view of the strap 110 securing the conduit 20 to the tower 10. FIG. 6 shows the conduit 20 held tightly to the tower 10 by the strap 100. As can be seen in FIG. 6, in embodiments, conduit 20 has a hollow area 26 configured to receive wires, optical fibers, and/or other lines.

Embodiments can be used to secure items other than conduit to the tower 10 or other structure. For example, a single wire, cable, or other item having recesses or grooves in its outer surface can be secured by an embodiment of the strap 100.

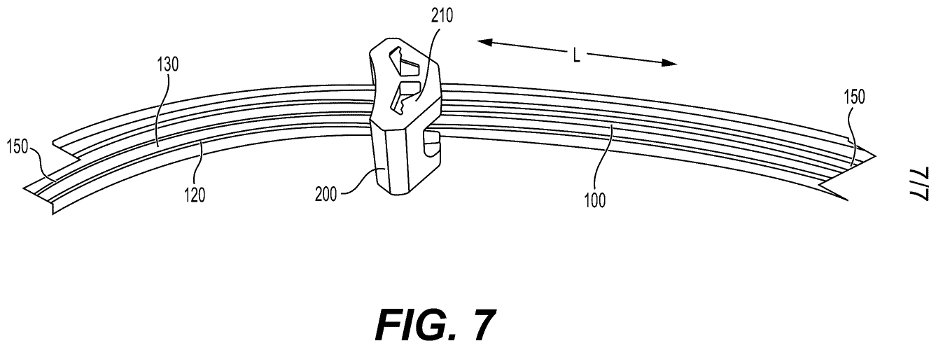

In embodiments, the strap 100 is secured at at least one location to another portion of the strap 100 to keep the strap 100 in a tightened condition on the conduit 20 and the tower 10. FIG. 7 shows a short section of the strap 100 as an example having ends 150. At one or both of the ends 150, or at one or more other locations along the length L of the strap 100, a clip 200 or other device secures the strap 100 to itself to keep the strap in a tightened condition on the conduit 20 and the tower 10. In embodiments, the clip 200 has one or more engagement portion 210 located, for example, at an interior area of the clip 200 that is configured to engage the strap 100 so as to prevent the strap 100 moving relative to itself at the location of the clip 200. Clips having other configurations can also be used with the strap 100 to keep the strap 100 in a tightened condition on the conduit 20 and the tower 10.

Although the illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

Various changes to the foregoing described and shown structures will now be evident to those skilled in the art. Accordingly, the particularly disclosed scope of the invention is set forth in the following claims.

What is claimed is:

1. An attachment device configured to attach a conduit to a support and to relieve strain on the conduit, comprising:
a body portion;
a protruding portion extending from the body portion;
wherein the body portion has a length in a longitudinal direction, has a height perpendicular to the longitudinal direction, and has a thickness perpendicular to the height and the longitudinal direction;
wherein the body portion has a first end and a second end, wherein the second end is opposite to the first end along the length of the body portion;
wherein the protruding portion extends from the body portion by a depth in a direction of the thickness of the body portion;
wherein the protruding portion extends along the longitudinal direction of the body portion;
wherein the protruding portion is structurally configured to engage a recessed portion of a conduit; and
wherein the protruding portion is structurally configured to engage the conduit to prevent movement of the conduit relative to the attachment device in a direction of the height of the attachment device so as to relieve strain on the conduit resulting from a hanging weight of the conduit.

2. The attachment device of claim 1, wherein the protruding portion extends uniformly along the longitudinal direction of the body portion.

3. The attachment device of claim 1, wherein the protruding portion extends along an entire length of the longitudinal direction of the body portion.

4. The attachment device of claim 1, wherein the protruding portion extends along less than an entire length of the longitudinal direction of the body portion.

5. The attachment device of claim 1, wherein the protruding portion is separated in the longitudinal direction by a gap between portions of the protruding portion.

6. The attachment device of claim 5, wherein the protruding portion is separated in the longitudinal direction by gaps between portions of the protruding portion, and the gaps are spaced along the longitudinal direction.

7. The attachment device of claim 6, wherein the gaps are spaced along the longitudinal direction at uniform intervals.

8. The attachment device of claim 1, wherein the protruding portion is a first protruding portion and the attachment device further comprises a second protruding portion.

9. The attachment device of claim 8, wherein the first protruding portion and the second protruding portion are spaced apart in a direction of the height of the attachment device.

10. The attachment device of claim 9, wherein the attachment device further comprises a third protruding portion, and the first protruding portion, the second protruding portion, and the third protruding portion are uniformly spaced apart in the direction of the height of the attachment device.

11. The attachment device of claim 1, wherein the recessed portion comprises a groove in the conduit.

12. The attachment device of claim 1, wherein the protruding portion has a cross-sectional shape, and the cross-sectional shape of the protruding portion comprises a triangle.

13. The attachment device of claim 1, wherein the protruding portion has a cross-sectional shape, and the cross-sectional shape of the protruding portion comprises a trapezoid.

14. The attachment device of claim 1, wherein the protruding portion has a cross-sectional shape, and the cross-sectional shape of the protruding portion comprises a U-shape.

15. An attachment device configured to attach a conduit to a support and to relieve strain on the conduit, comprising:
a body portion;
a protruding portion extending from the body portion;
wherein the body portion has a first end and a second end, wherein the second end is opposite to the first end along a length of the body portion, the length extending in a longitudinal direction of the body portion;
wherein the protruding portion extends from the body portion by a depth in a direction of a thickness of the body portion;
wherein the protruding portion extends along the longitudinal direction of the body portion; and
wherein the protruding portion is structurally configured to engage a conduit to prevent movement of the conduit relative to the attachment device in a direction of a height of the attachment device so as to relieve strain on the conduit resulting from a hanging weight of the conduit.

16. The attachment device of claim 15, wherein the protruding portion is structurally configured to engage a recessed portion of the conduit.

17. The attachment device of claim 15, wherein the protruding portion extends uniformly along the longitudinal direction of the body portion.

18. The attachment device of claim 15, wherein the protruding portion extends along an entire length of the longitudinal direction of the body portion.

19. The attachment device of claim 15, wherein the protruding portion extends along less than an entire length of the longitudinal direction of the body portion.

20. An attachment device configured to attach a conduit to a support and to relieve strain on the conduit, comprising:
a body portion;
a protruding portion extending from the body portion;
wherein the protruding portion extends from the body portion a protrusion depth;
wherein the protrusion depth is in a direction of a thickness of the body portion;
wherein the protruding portion extends along a longitudinal direction of the body portion; and
wherein the protruding portion is structurally configured to engage a conduit to prevent movement of the conduit relative to the attachment device in a direction of a height of the attachment device so as to relieve strain on the conduit resulting from a hanging weight of the conduit.

21. The attachment device of claim 20, wherein the body portion has a first end and a second end, the second end being opposite to the first end along a length of the body portion, the length extending in the longitudinal direction of the body portion.

22. The attachment device of claim 20, wherein the protruding portion is structurally configured to engage a recessed portion of the conduit.

23. The attachment device of claim 20, wherein the protruding portion extends uniformly along the longitudinal direction of the body portion.

24. The attachment device of claim 20, wherein the protruding portion extends along an entire length of the longitudinal direction of the body portion.
